(19) United States
(12) Patent Application Publication
(10) Pub. No.: US 2016/0158783 A1
(43) Pub. Date: Jun. 9, 2016

(54) Sprinkler System

(71) Applicant: Warren R. Wiebe, Incline Village, NV (US)

(72) Inventor: Warren R. Wiebe, Incline Village, NV (US)

(21) Appl. No.: 14/645,369

(22) Filed: Mar. 11, 2015

Related U.S. Application Data
(60) Provisional application No. 62/088,648, filed on Dec. 7, 2014.

(51) Int. Cl. B05B 12/12; G05B 15/02; A01G 25/16; B05B 9/03; B05B 12/00

(52) U.S. Cl. CPC B05B 12/12; B05B 9/03; B05B 12/008; A01G 25/165; A01G 25/16; G05B 15/02

(57) ABSTRACT

Methods and apparatus, including computer program products, implementing and using techniques for controlling a sprinkler system are described. The sprinkler system includes one or more sprinkler units. At least some sprinkler units include: a variable speed rotation motor, a flow valve, and a control module. The variable speed rotation motor and the flow valve are configured to apply different amounts of water to different regions of an area irrigated by the sprinkler unit, in response to instructions received from the control unit.

### BACKGROUND

The present invention relates to irrigation systems, and more specifically, to a programmable sprinkler system. Existing residential sprinkler systems are designed around various irrigation technologies that include but are not limited to drip (micro) irrigation, spray heads, and impact heads.

Drip irrigation (also referred to as micro irrigation) uses a highly focused drip (point delivery) system or a system of light spray heads (≦1 sq. m) to irrigate very small areas. Typically, multiple drip heads are connected to a flexible central supply line, which in turn is connected to a manually controlled water spigot or electrically controlled sprinkler valve and a central controller/timer. Multiple such systems may be connected in “zones” to a central controller/timer.

In a spray head system, an array of spray heads is connected to a rigid sprinkler pipe, which is connected to a manually or electrically controlled sprinkler valve and optionally a central controller/timer. The spray heads provide for adjustable flow and are designed to cover much larger areas, up to 30 sq. m or even more given sufficient water pressure. Typically, each spray head is designed to water a circular area with a fixed arc (typically in the range of about 45° to about 360°). Some spray heads are also adjustable for a variable arc of spray, from as little as 15° on up. Some spray heads include multiple spray heads of varying volume to spray inside the outer perimeter and “fill in” between the head and the outer perimeter.

The spray heads are laid out in a “head to head” configuration, in which the spray from each spray head is intended to reach the next spray head with substantial overlap. This is because the spray pattern is fixed from the heads and does not evenly distribute water within the arc. The “head to head” configuration allows other heads to irrigate the area closest to each head. Large irrigation areas are covered by the use of multiple overlapping zones, typically still making use of the “head to head” configuration across zones.

Very large irrigation areas, such as large lawns, golf courses, parks, etc. make use of impact spray heads. Impact heads project a single stream of high-pressure water that is impacted by a spring-loaded arm. The impact disrupts the water stream and disperses the water between the spray head and the outer perimeter of the spray arc. Typically, impact heads are adjustable for both flow volume and the rotation arc.

FIG. 1 shows an example of how these sprinkler technologies may be used in a typical residential installation. As can be seen in FIG. 1, the selection of which type of spray heads to use is largely based on the size and shape of the area to be irrigated. Very large and broad spaces are well suited for the use of impact heads, whereas smaller, oddly shaped and/or tight areas are better suited for the use of spray heads, or even drip irrigation. Some installations make use of a combination of irrigation technologies.

### SUMMARY

According to one aspect of the present invention, a sprinkler system is described. The sprinkler system includes one or more sprinkler units. At least some sprinkler units include: a variable speed rotation motor, a flow valve, and a control module. The variable speed rotation motor and the flow valve are configured to apply different amounts of water to different regions of an area irrigated by the sprinkler unit, in response to instructions received from the control unit.

According to another aspect of the present invention, computer-implemented methods and computer program products are provided for controlling a sprinkler unit. A user input is received, which defines one or more areas to be irrigated by the sprinkler unit. The sprinkler unit includes a variable speed rotation motor, a flow valve, and a control module. A spray pattern to achieve desired irrigation of the one or more areas is determined. The determined spray pattern is stored in a memory of the control module. Instructions stored in the memory of the control module are executed to irrigate the one or more areas in accordance with the determined spray pattern.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows an example of how a combination of conventional sprinkler technologies may be used in a typical residential installation

FIG. 2 shows a design of a conventional irrigation system for a polygonal lawn.

FIG. 3 shows a design of an irrigation system in accordance with one embodiment of the invention for the polygonal lawn of FIG. 2.

FIG. 4 shows the use of multiple rotational passes to irrigate swaths of the polygonal lawn of FIG. 2, in accordance with one embodiment of the invention.

FIG. 5 shows the concept of special irrigation zones of the polygonal lawn of FIG. 2, in accordance with one embodiment of the invention.

FIG. 6 shows a schematic block diagram of a sprinkler unit, in accordance with one embodiment of the invention.

FIG. 7 shows a flowchart of a method for operating the sprinkler unit, in accordance with one embodiment of the invention.

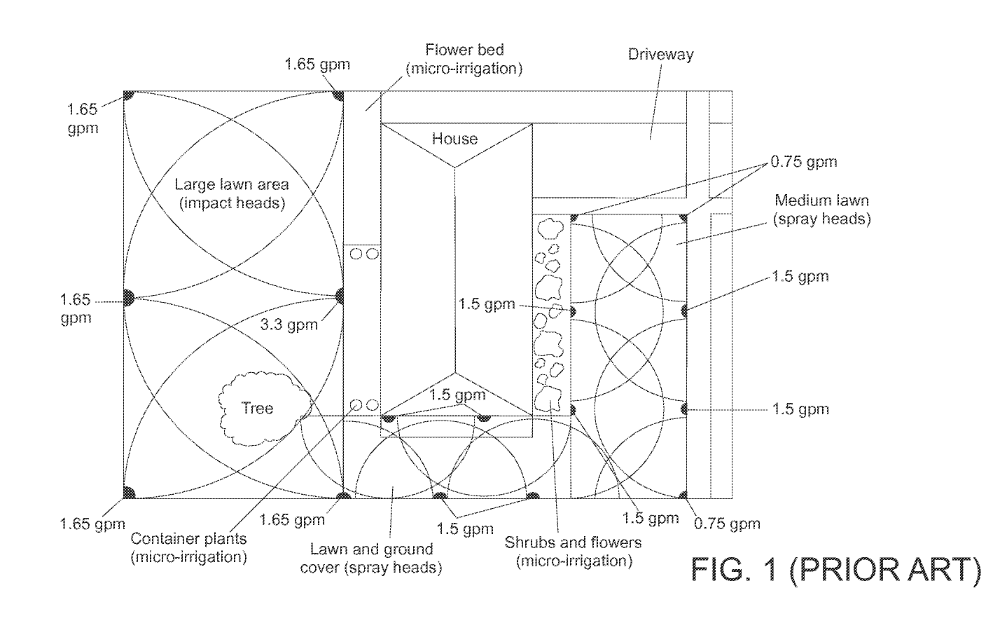

Like reference symbols in the various drawings indicate like elements.

### DETAILED DESCRIPTION

### Overview

The various embodiments of the invention described herein relate to sprinklers and sprinkler systems. In one embodiment, the sprinkler system includes a single sprinkler unit and a computer application (such as a tablet computer application, for example), which is used to program the sprinkler unit. Other embodiments may include additional components, such as additional sprinklers programmed to work together, a local weather station, and a central controller, for example. A single computer, such as a tablet computer, for example, may be used to program multiple sprinklers.

In one embodiment, the sprinkler unit includes a computer controlled, powered sprinkler head, which is capable of irrigating any size shape of lawn or garden area within the throw limits of the projected water flow, subject to obstructions. Internally, the sprinkler unit may contain a memory that stores a map of the area to be irrigated and the programming logic to direct water to irrigate any area with the exact amount of water desired, even if that amount varies from location to location inside the mapped area. However, as the skilled person realizes, there can also be embodiments in which the map is stored in the computer and the sprinkler head communicates continuously or periodically with the computer and executes instructions provided by the computer.

The mechanical controls within the sprinkler unit serve to rotate one or more internal spray heads of the sprinkler unit through a 360° (or smaller) arc while mechanically adjusting one or more of: the rate of flow, angle of ejection and the shape of the projected water dynamically for each sprinkler head at each point along the arc, per its programming, to cover the desired area. The resulting flow covers at least a portion of the map with each full rotation of the sprinkler head. For example, while the first full rotation may cover the perimeter of the desired area represented by the map, successive rotations may reduce the flow of the water (or other fluid) to cover additional swaths of the map until the entire area is thoroughly irrigated.

In order to get a more intuitive understanding of the functioning of the sprinkler system in accordance with the various embodiments, please consider the following example. Imagine attaching a ⅜″ flexible hose to a garden hose and turning on the water full blast. Holding the ⅜″ hose parallel to the ground, the water exits the hose in a nearly laminar arc pattern as if it were still passing through the hose until the water hits the ground. Now, angle the hose upwards and observe how the water now flows in a parabolic shape. The distance the water travels (also referred to as the “throw”) can thus be changed by altering the vertical angle at which it is projected.

Now imagine pinching the end of the hose from both sides. In so doing, the water disperses vertically as if extending the angle formed at the top and bottom of the pinched hose end. Pinching the hose also increases the pressure, which causes the water to project farther and disperse more. The dispersion and throw of the water can be changed by pinching harder or loosening the pinch.

To complete the mental picture of the sprinkler unit operation, move the hose horizontally in a circular motion as if watering a large area. Alter the angle and pinch of the hose to project farther, and reduce the flow of the hose (from the spigot) to project closer.

These are the basic principles on which the various embodiments of the sprinkler unit operate. It follows a defined program to mechanically adjust valves and controls for flow, elevation, and dispersion while rotating through a 360° pattern to irrigate a defined area of any shape. The size of that area is limited only by the incoming water pressure.

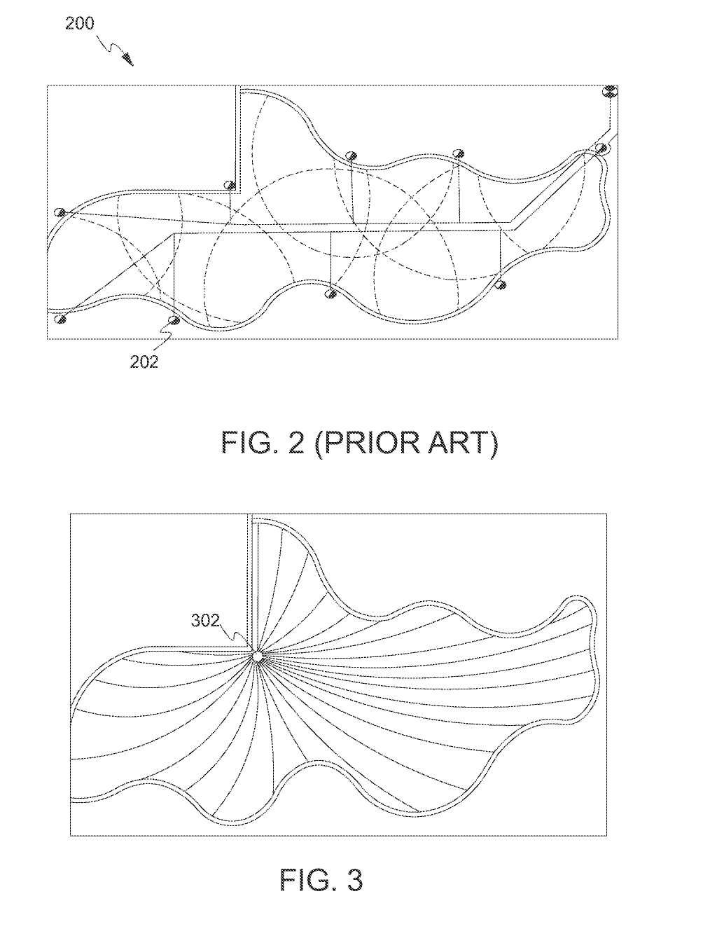

FIG. 2 shows a typical design of a conventional irrigation system 200 for a polygonal lawn. The total area is 65 ft.×25 ft. square or roughly 1,050 sq. ft. As can be seen in FIG. 2, no less than ten separate sprinkler heads 202 are required to water this area. Such an irrigation system has a number of associated disadvantages. For example, it requires extensive (and expensive) pipe runs and risers; because of the overlapping spray patterns (as shown by the dashed semi-circular lines in FIG. 2) the system wastes water; and there is also an overspray into planting beds and hardscape outside the lawn perimeter.

In contrast, FIG. 3 shows the same lawn with a single sprinkler unit 302 installed, in accordance with one embodiment of the invention. As can be seen in FIG. 3, the single sprinkler unit 302 can irrigate the entire lawn and replace the ten sprinkler heads shown in FIG. 2.

The sprinkler unit 302 accomplishes this by varying one or more of: the flow (and thereby the throw), the angle of ejection, the shape (i.e., dispersion) and the rotation speed to water the entire area through a series of rotational passes at varying flow rates.

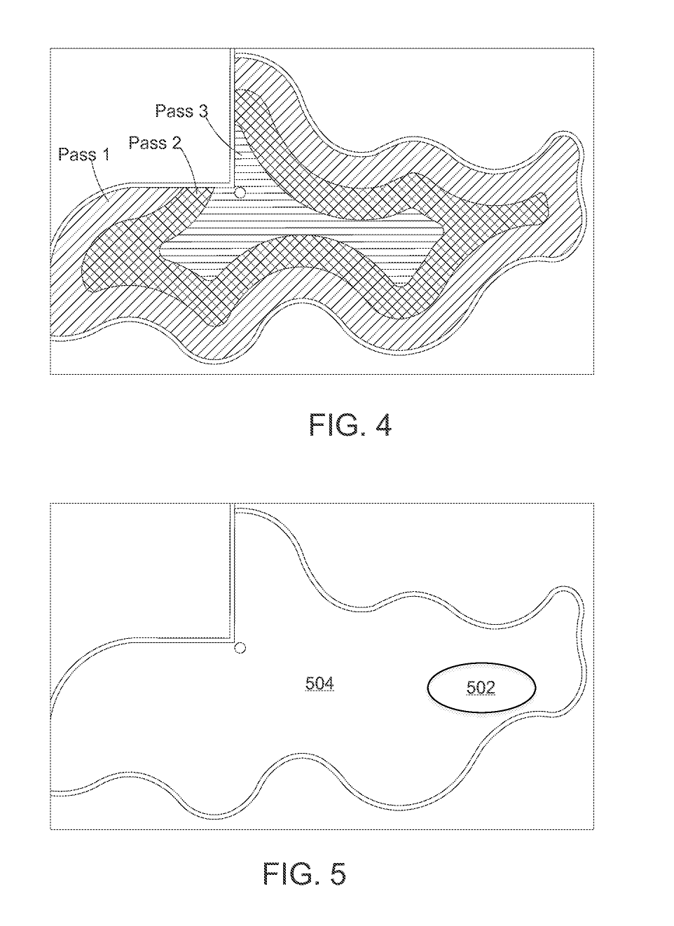

FIG. 4 shows the use of multiple rotational passes to irrigate adjacent swaths of the lawn to achieve full coverage, in accordance with one embodiment. Variation of the rotation speed can alter the fluid delivery to water the lawn in a single cycle (3 rotational passes, as shown in FIG. 4). Alternatively, for lawns that absorb water slowly, multiple cycles could run in succession or with a certain delay to improve water absorption.

In one embodiment, the internal map can be represented as a matrix of points within the reach of the sprinkler unit, which points define the desired irrigation area. Each point in the matrix notes an amount of water to be delivered to that point and, by implication, the immediate surrounding area

In some embodiments, multiple maps can be maintained within the sprinkler unit to define not only the full area to be irrigated, but also “special irrigation zones” which require more or less watering or an alternate schedule from that of the main area. This is schematically illustrated in FIG. 5, where zones 502 and 504 are represented by different maps, and each zone requires a different amount of water. In some embodiments, an internal clock and a controller in the sprinkler unit define the schedule with which each mapped area is to be irrigated. In other embodiments, for example, where there is a central irrigation controller, these functions may be disabled in the sprinkler unit itself

Some embodiments of the sprinkler unit can be used as a standalone system using its own internal timing controls. Other embodiments can be integrated with an existing sprinkler timer for legacy installations. Additionally, some embodiments of the sprinkler unit can communicate with a dedicated weather station in the immediate area to compensate for hyper-local weather changes (i.e., real-time weather data within roughly 100 meters of the defined irrigation area). Various types of compensation for weather changes may include, for example, reducing or delaying watering in response to rain, wind or overcast conditions, and dynamically adjusting direction and flow to compensate for real-time wind, just to give a few examples.

When using the internal Ethernet or WiFi connection, the sprinkler unit can be connected to the Internet for access to local weather forecasts to avoid watering on, just before, or just following local rain, or accelerate or delay watering to avoid peak wind forecasts.

The computer application aids in making all of the technology described above accessible to professionals and laypeople alike. Functions of the computer/tablet application include, for example:
Setting the date and time
Defining a map of boundaries of each area to be irrigated
Defining special irrigation zones and irrigation parameters
Defining an irrigation schedule and timing for each mapped area
Defining characteristics of shade producing objects, such that less water can be applied to shaded areas.

All of these functions can be performed in a graphics rich intelligent user interface (GUI) on the computer. The resulting parameters are then downloaded to the sprinkler unit using wireless techniques, such as Bluetooth LE or WiFi, for example.

Various embodiments of computer applications are described in much greater detail below. It should be noted in this context that the term “computer application” encompasses any computer application that can be run on any computer device, such as a desktop, laptop, tablet computer, cellphone, etc., and should thus be construed broadly.

### Examples of Advantages

This section lists some of the many advantages that can be accomplished when using a sprinkler system in accordance with the various embodiments of the invention, compared to conventional spray and impact heads.

Existing sprinkler technologies are all based on the ability of a sprayed arc of a preset distance to uniformly irrigate areas of any shape. This can result in over-watering of overlap areas (i.e. “wet spots”), under-watering of gap areas (i.e., “dry spots”), or overspray outside of intended boundaries.

Other common problems with existing sprinkler technologies include water damage to adjacent structures and paths, discoloration of adjacent trees, weed growth in plant beds, bare soil, and groundcover, watering beyond the property boundaries, and unnecessary wasting of water in overlap and overspray areas.

Further, existing sprinkler technologies all rely on the installation of multiple heads, with labor intensive installation of a network of underground pipes and valves to supply them. This results in expensive installation costs as well as expensive long-term maintenance costs.

Existing sprinkler technologies are also unable to compensate for observed wet and dry spots, as can be done with the various embodiments of the current invention. This inability to compensate for wet and dry spots results in expensive reconfiguration of pipes, heads, and sometimes valves and controllers.

Existing sprinkler technologies are unable to compensate for shade producing trees, structures, etc., as can be done with the various embodiments of the current invention. This results in overwatering heavily shaded areas (i.e., “wet spots”).

Existing sprinkler technologies are unable to compensate for hyper-local weather impacts, as can be done with the various embodiments of the current invention. This inability results in, for example, wind deflection of sprayed water into unintended areas, failure to apply the intended water volume to areas up wind, and watering on, in advance of, or just after rainy days.

The sprinkler systems in accordance with the various embodiments of the invention address all of the above-mentioned failures of traditional sprinkler solutions through intelligent computer control, programmable logic control, and dynamic real-time processing.

### Working Principles

Water, and fluids in general, flow in predictable patterns, which can be mathematically modeled, as is well known to those having ordinary skill in the art. Given a specific rate of flow, and known shapes of the channels through which the water flows, and the vertical angle at which the water is released, it is possible to calculate the shape of the water flow, the distance it will throw, the distribution of the water flow throughout the shape, and ultimately the amount of water to be delivered anywhere within the projected spray.

Given the ability to control all of the above parameters, the sprinkler system can reliably calculate and execute the optimal spray pattern to irrigate any defined space with virtually no overlap, gaps, or overspray. Furthermore, given real-time data on local and hyper-local weather, it can avoid overwatering resulting from shade, overcast, or rainy conditions.

### Mechanical Design Concepts

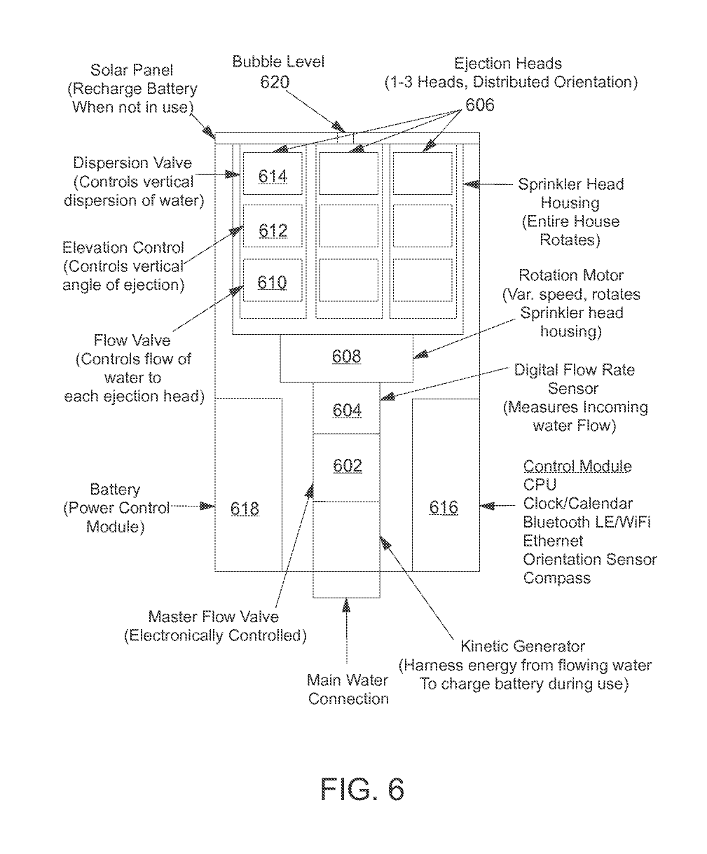

FIG. 6 shows a schematic block diagram of a sprinkler unit 600, in accordance with one embodiment. As can be seen in FIG. 6, the sprinkler unit 600 includes the following mechanical components, in order from the incoming water supply to the ejection nozzle.

A master flow valve 602 controls the flow of incoming water to the sprinkler head 600. The master flow valve 602 limits the flow of the incoming water to a value, which is set as part of the original programming of the sprinkler unit 600. Limiting the maximum water pressure internal to the sprinkler unit 600 provides a more predicable and reliable flow rate on which calculations can be based and avoids possible damage from excessive incoming pressure.

A flow rate sensor 604 measures the actual flow rate of water into the mechanical sprinkler head so that the master flow valve 602 can be opened or closed as needed to arrive at the ‘optimal’ flow for the sprinkler program.

The water then flows into the rotating sprinkler module. This module includes one or more ejection heads 606 that project the outgoing spray pattern. The entire module rotates using a variable speed motor 608 which allows the sprinkler module to rotate through the entire 360° arc. However, it should be realized that in some embodiments the arc may be less than 360°. There may also be embodiments in which the motor 608 has a constant speed rather than a variable speed and the spray pattern is regulated by only regulating the water flow.

Inside the sprinkler module are one or more ejection heads 606, each of which controls a stream of outgoing water. Each ejection head 606 includes mechanical controls for flow 610, elevation (up/down) 612, and dispersion (vertical distribution of water spray) 614. In some embodiments that contain only a single ejection head 606, the flow valve 610 internal to the ejection head 606 may not be left out.

Unrelated to the water flow, but internal to the sprinkler unit 606 is a control module 616 which includes one or more of the following components:
Central Processing Unit (CPU)
Clock/Calendar
Bluetooth LE and/or WiFi (wireless)
Ethernet (wired) communications with Power-over-Ethernet (PoE)
Orientation Sensor
Compass

Power to the control module can be provided by any conventional power source, such as a battery 618, or wired Power-over-Ethernet (PoE), or a combination of solar (trickle charge) and/or kinetic energy powered by the flow of the water through the sprinkler unit 600.

In some embodiments, a small bubble level 620 is included on the top of the sprinkler unit to aid in installation so that the sprinkler unit 600 is perfectly level when installed. Some embodiments of the sprinkler unit 600 can also contain an orientation sensor that allows the sprinkler unit 600 to programmatically determine its level state in two dimensions. Sprinkler units are frequently displaced following installation, which, if moved from level, can affect the elevation of the sprayed water. A sprinkler unit which is not level may not be able to reliably cast a uniform spray of water in a 360° arc.

In some embodiments, a visual North indicator can also be provided for installation so that a reference direction is always known for any programmed spray pattern. An internal compass can be included to programmatically evaluate any orientation displacement that may otherwise result in irrigating outside of the intended boundary line.

Once properly installed, leveled and oriented, and knowing the incoming flow of water, the sprinkler unit 600 can execute a scheduled (or centrally driven) watering plan, calculate the optimal irrigation plan, and adjust flow, elevation, and dispersion dynamically with rotation to irrigate the mapped area with a uniform volume of water throughout, adjusting for special irrigation zones as previously discussed, and compensating for calculated shadows cast in the mapped area.

### Programming Concepts

In some embodiments, programming of the sprinkler unit 600 can be accomplished through the use of a separate computer, such as a portable tablet computer, laptop, cellphone and the like, equipped with Bluetooth LE and/or WiFi communications to communicate with the sprinkler unit 600. If connected to a home network via Ethernet or a wireless connection, the programming can also be done via desktop computer connected to the home network. Additionally, in order to benefit from shade prediction algorithms, the computer is preferably equipped with internal or outboard GPS capability.

The application program on the computer has a graphical user interface (GUI), through which all mapping can be done and data can be entered. The resulting dataset is downloaded to the sprinkler unit for storage and subsequent execution. In addition, real-time control and interaction with the sprinkler unit are supported while programming, or testing stored programs. In some embodiments, web-based GUIs may be included, such that the mapping and data can be entered and accessed from a variety of devices in a location-independent manner. For example, a user may access a map of his yard and select a watering schedule while being in his office, and then update the sprinkler unit with the new data when he arrives home at the end of the day.

The maps, watering schedules, etc., can be stored on one or more local or remote servers in a so-called “cloud computing” environment, where the data can be accessed by the user from essentially any device, for example, by the user logging onto the server with a username and a password. Such central storage of maps, watering schedules, etc. also provides for central analysis of usage patterns of the irrigation system by the users and the ability to analyze those usage patterns to suggest “water wise” tips to improve sprinkler use in order to save water. Furthermore, centralized analysis of usage data sent by the sprinklers can allow for periodic reporting of water usage, deferrals (reschedules), etc. to the user, along with recommendations. Aggregated data can also be provided to local water providers, even in an anonymized fashion, if so desired.

### Mapping

The mapping process is the process through which the area to be irrigated is defined. In some embodiments, the mapping starts with either a blank canvas or a background drawing such as a CAD (computer aided design) drawing or a Google Earth™ image of the area.

If a background image is used, the user can draw an outline of the perimeter of the area to be irrigated using the background image as a stencil. The user can then indicate the exact position of the sprinkler unit on the image and measure the distance from the sprinkler unit position to any two or more points in approximately 90 degree opposition along the perimeter line, recording the distances in the computer application. Using this information, the computer application can calculate the exact distances to every point on the perimeter line.

Alternatively, for systems that include an outboard GPS device, the user could pinpoint the desired sprinkler unit position using GPS, and then walk the perimeter of the intended area while the computer application records the perimeter route, thus defining the boundaries of the area to be irrigated.

It should be noted in this context that a single sprinkler unit can support multiple maps of different areas. For example, a single sprinkler unit can be used both for irrigating a lawn area and surrounding shrubs (even with a targeted water stream), on the same schedule or on separate schedule. There may also be “special irrigation zones”, such as a decorative rock or a xeriscaped island in the midst of a lawn, which requires no or very little watering.

Once the map is determined through either of the above processes, the map can be tested by running a sample perimeter irrigation cycle. During the test, the user may increase or decrease flow to compensate for such factors as slope, which may not be accurately captured from the background image or by the GPS device. For example, up-sloping lawns may result in underspray, i.e., inability to reach the perimeter, and down-sloping lawns may result in overspray, i.e., spraying beyond the perimeter of the lawn.

In embodiments in which no background image is available and no GPS is used, the user can effectively program the map using real-time manual controls of the sprinkler head, either through the GUI on the computer application, or through manual controls on the sprinkler unit. These controls include the ability to rotate the sprinkler unit to a starting point, increase or decrease the water flow (and the resulting water stream coming from the sprinkler unit), and stop/start the rotational motor. Using these controls, the user could trace the perimeter of the map area using the ejected water, increasing or decreasing flow at each point along the arc, to map the perimeter—stopping at any point to end the programming and saving the programmed data.

Use of either of the above processes defines the outline of the area to be irrigated. The result is a map of the base irrigation zone. As mentioned above, the user can then draw (using their fingers or graphic tools) special irrigation zones, which will layer on top of the base irrigation zone, for increased or decreased irrigation (+/−x%). Special irrigation zones are designed, for example, to provide additional water to dry spots, or less water to soggy areas as needed, or to exclude areas inside the map that do not require watering. Commercial examples might include tee boxes and greens on golf courses, which use different types of grass which may require more or less watering; or bunkers, water hazards or cart paths which are routinely, but preferably never watered.

Each defined zone can be named by the user for ease of reference and watering volumes and schedules can be defined. Watering volumes may be additive (more water than base) or reductive (less water than base). The special irrigation zones can be defined at any time after the initial map has been created. In fact, in many cases, the special irrigation zones are defined in response to a user discovering dry spots or wet spots in the irrigated area, which may need to be adjusted such that an appropriate amount of water is applied to the dry or wet spot.

### Scheduling by Zone

In some embodiments, watering schedules may be defined using any of the following methods:
Specific days of the week, i.e. Mon, Wed, Fri
Specific day intervals, i.e. every other day, every 3rd day
Specific days of the month, i.e. 1st and 3rd Wednesday of the month
Specific times of the day, i.e. 10:00 AM and 4:00 PM
Times relative to sunrise/sunset, i.e. 30 minutes before sunrise

It should be noted that this is a non-exhaustive list and that there may be a number of different watering schedules that can be envisioned by those having ordinary skill in the art. The flexibility with which watering schedule can be defined also allows the sprinkler unit to comply with all local water ordinances.

By default, all special irrigation zones use the same schedule as the base irrigation zone, and therefore additive and reductive volumes will result in a net calculation of the volume of water to be delivered to any point. However, as the skilled reader realizes, any special irrigation zone can just as well be watered on its own schedule, independent of the base schedule. In some embodiments, the GUI provides the ability for the user to place a pointer and see exactly how frequently and in what volume any point will be irrigated.

Being able to precisely control the watering in different zones also allows a user to know exactly how much water will be used, and thereby get an idea about how much the irrigation will cost on, say, a day-to-day basis, such that the user can get a very accurate sense of the cost of the watering and also comply with local water budgets.

### Shadow Forecasts

One feature of some embodiments of the sprinkler unit is the ability to dynamically compensate for shadows cast by surrounding objects in the mapped area. Areas that are frequently shaded require less water than non-shaded areas and can therefore frequently result in soggy areas of lawn or soil. Compensating for cast shadows can also save a significant amount of water.

Forecasting the position of shadows throughout the day, and compensating for changes during the seasons as the sun changes position requires knowing the precise location of the objects casting shadows, as well as their width, height, and density.

In some embodiments, the computer application provides two ways to define these objects. First, there is a simple placement algorithm with which the user can select an object type using libraries of structures, trees, etc., then picking and placing structures where they reside relative to the mapped area on the GUI. Each placed object will require width, height, and density (0-100% opacity).

Second, optionally, the computer application supports an interface to highly accurate outboard GPS positioning equipment wherein the user can walk the perimeter of existing shadows, and the computer application calculates, knowing the precise date and time, the position of the sun and thereby the location, shape and height of the object. In addition to walking the perimeter of the existing shadows, the user also needs to indicate the point of origin of the shade-producing object (e.g., using GPS coordinates). Typically, for each group of shadow-casting objects, it is sufficient for the user to pinpoint the position of the tallest shadow-casting object only in the group of objects and the equivalent point on the shadow that is cast. With this information at hand, the computer application can calculate the other parameters, as described above.

Using either method, the computer application can calculate a period specific shade index for each point in the mapped area. The anticipated periodicity can be, for example, 30 days. Thus for each 30 day period, the computer application can calculate a measure of the shade cast at each point by calculating the position of the shade in, for example, 15-minute intervals (or some other interval set by the user) between sunrise and sunset. A default table of volume adjustments based on shade volume can be provided, but may be edited by the user.

If a hyper-local weather station is used, the user can additionally indicate the location of the weather station on the map. This location information can be used in the calculation of the real-time impact of winds on the projected water stream from the sprinkler unit.

If an Internet connection is active, either through Ethernet, WiFi or Bluetooth, the sprinkler unit can also increase or decrease watering based on low and high temperatures, overcast or cloudy conditions, or rain as reported through readily available Internet weather data. This adjustment may include disabling shadow forecast adjustments based on overall overcast or cloudy conditions.

### Preprogramming/Simulation

Once all of the variables above have been defined, the computer application calculates the optimal sprinkler unit programming to deliver the desired water (fluid) level to each location in the desired irrigation area. The result will be a visual simulation of the programmed operation of the sprinkler unit, which can be reviewed by the user. Run times, and calculated fluid volumes at each location are determined, with any resulting issues (variations from desired levels) highlighted for the attention of the user. This simulation can result in, for example, the user shortening the runtime of the watering if the simulation shows that the calculated cycle is longer than desired, etc.

The algorithm for defining this optimal programming can be replicated within the sprinkler unit hardware. In some embodiments, the sprinkler unit resident version of the algorithm can also be optimized for factoring in real-time wind speed and direction.

### Execution Concepts

The end results of the programming methods described above are one or more of the following variables that reside in the sprinkler unit 600:
A map of the area to be irrigated, made up of, for example, a two dimensional matrix of points of defined spacing (e.g., 4″ radius) including the entire area within reach of the sprinkler head 600 at maximum flow. Each point references an amount of water (fluid) to be delivered to the point through the irrigation operation of the sprinkler unit 600. A seasonal shade index is calculated as part of the programming and stored for each point.
A schedule associated with each map indicating the frequency with which each map is to be irrigated.
A default pre-programmed spray pattern is calculated in the computer application and downloaded to the sprinkler unit 600.

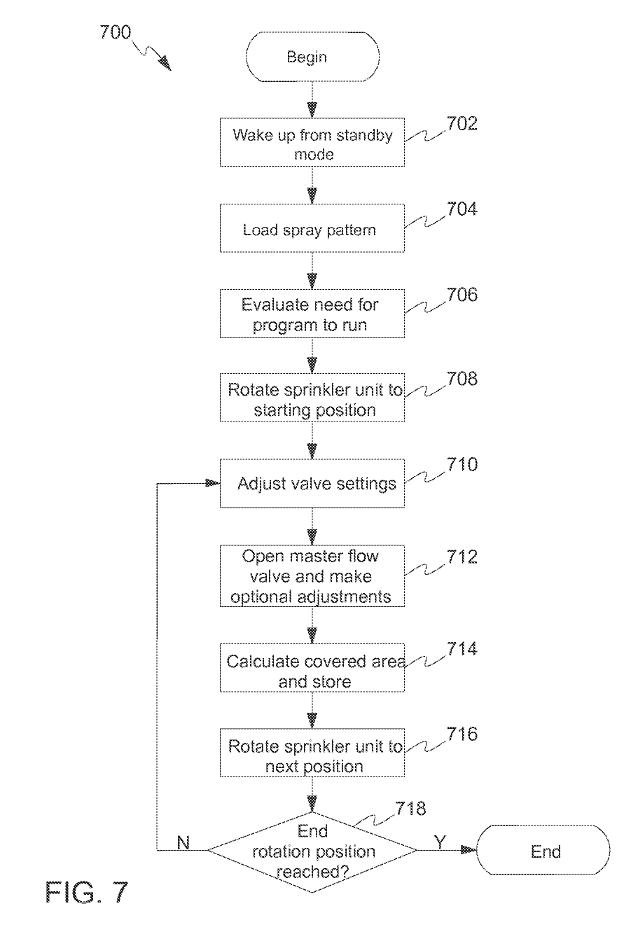

Execution of the programming begins at a scheduled time as indicated by the schedule for each map. In some embodiments, the program execution includes the following steps, which are illustrated in the flow chart in FIG. 7. As can be seen in FIG. 7, the process starts by the sprinkler unit waking up from standby mode in step 702. Next, the pre-programmed spray pattern is loaded in step 704. For subsequent passes, rather than loading the pre-programmed spray pattern, the area irrigated on the first pass is evaluated and the spray pattern is adjusted accordingly for omissions or over-irrigated areas.

Next, in step 706, an evaluation is made as to whether the program should be run. This evaluation can be made, for example based on weather data available from the Internet and/or from a hyper-local weather station, as described above. For example, if it is raining or if it is within the defined time parameters of a past or anticipated rain, then the program can be cancelled.

Next, the sprinkler head is rotated into the programmed starting position in step 708. The valve settings (i.e., flow, elevation and dispersion) are then adjusted for each ejection head in step 710 to the pre-programmed values. If a hyper-local weather station is available, further adjustments may optionally be done in this step to compensate for other parameters, such as wind speed and direction.

In step 712, the master flow valve is opened to the desired position to reach the predetermined master flow setting. If the programmed flow rate cannot be reached, the elevation and dispersion can be adjusted accordingly.

Next, in step 714, the covered area is calculated and stored. The sprinkler unit is then rotated to the next rotational position at the programmed speed, in step 716. It is then checked whether the end rotational position has been reached in step 718. If the end rotational position has not been reached, the process returns to step 710 and proceeds as described above. If it is determined in step 718 that the end rotation position has been reached, the first pass of the programmed irrigation has been reached and the process ends. This process 700 can then be repeated in the opposite direction, while adjusting the flow, elevation and dispersion as many times as needed to irrigate successive swaths of the intended irrigation area, until the last pass of the programmed irrigation has been reached. At this point, the sprinkler unit again enters standby mode until it is time for the next programmed irrigation session.

### SUMMARY

The sprinkler unit represents a significant advancement in both residential and commercial irrigation. It combines basic mechanical fluid flow controls with the programmatic ability to adjust those controls in real time to precisely irrigate within defined areas. It can deliver water precisely where, when and in the volume desired.

It eliminates the need for as much as 90% of sprinkler heads; replacing them with a single sprinkler head. In so doing, it avoids overlapping spray patterns, which waste water and produce overly moist and/or dry spots in any lawn.

Because the sprinkler system in accordance with the various embodiments described herein use fewer heads, the installation costs are much lower compared to conventional multiple head systems. It further has the ability to work as a standalone system or to integrate with legacy installation of older pipes and control hardware.

Because it is computer controlled, it has the ability to leverage readily available historical and forecast weather data to avoid watering in advance of, during, and following rain—thereby saving additional water resources.

The sprinkler unit also reduces water usage by at least an estimated 25% to 50%, which is a significant advantage in today's drought-stricken world.

The present invention may be embodied at least in part as a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the sprinkler systems described herein can be advantageously used in residential and commercial landscape irrigation, the concept is equally capable of distributing any sufficiently viscous fluid over any intended area. For example, in an airport setting, the sprinkler system can be programmed with the profiles of various types of aircraft to automate the application of de-icing liquids during the cold part of the year. This would not only reduce the manual labor needed in a working environment that is often hazardous, but also lead to considerable savings in de-icing liquid, which would have both environmental and cost benefits. Thus, no aspect of this patent application should be construed as limiting the scope of the concept to landscape irrigation only.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A sprinkler system comprising:
one or more sprinkler units, wherein at least some sprinkler units include:
a variable speed rotation motor,
a flow valve, and
a control module,
wherein the variable speed rotation motor and the flow valve being configured to apply different amounts of water to different regions of an area irrigated by the sprinkler unit, in response to instructions received from the control unit.

2. The sprinkler system of claim 1, further comprising a user interface for enabling a user to provide user input to the control unit.

3. The sprinkler system of claim 1, wherein the at least some sprinkler units further include:
a master flow valve for limiting the flow of incoming water to the sprinkler unit; and
a flow rate sensor for measuring the flow of incoming water, wherein the control unit is further configured to control the master flow valve in response to the measured flow by the flow rate sensor.

4. The sprinkler system of claim 1, wherein the at least some sprinkler units further include one or more ejection heads configured to control a stream of outgoing water from the sprinkler unit.

5. The sprinkler system of claim 4, where each ejection head includes mechanical controls for flow, elevation and dispersion.

6. The sprinkler system of claim 1, wherein the at least some sprinkler units further include a power source for providing power to various components of the sprinkler unit.

7. The sprinkler system of claim 1, wherein the control module further includes one or more of: a central processing unit, a memory, a clock, a calendar, wireless connectivity components, wired connectivity components, an orientation sensor, and a compass.

8. The sprinkler system of claim 7, wherein the memory stores one or more maps of the area to be irrigated by the sprinkler system.

9. The sprinkler system of claim 7, wherein the control module further is configured to obtain local weather data from a weather station or from the Internet and adjust the irrigation based on the obtained data.

10. A computer-implemented method for controlling a sprinkler unit, the method comprising:
receiving a user input defining one or more areas to be irrigated by the sprinkler unit, the sprinkler unit including a variable speed rotation motor, a flow valve, and a control module;
determining a spray pattern to achieve desired irrigation of the one or more areas;
storing the determined spray pattern in a memory of the control module; and
executing instructions stored in the memory of the control module to irrigate the one or more areas in accordance with the determined spray pattern.

11. The method of claim 10, wherein the one or more areas to be irrigated are represented by one or more maps made up of a matrix of points, wherein each point references an amount of water to be delivered to the point by the sprinkler unit.

12. The method of claim 11, further comprising calculating a shade index for each point on the one or more maps.

13. The method of claim 10, further comprising determining a schedule for how often the area should be irrigated, and irrigating the area in accordance with the determined schedule.

14. The method of claim 13, wherein the determination is made at least in part based on available local weather data.

15. The method of claim 10, wherein receiving a user input defining one or more areas to be irrigated includes receiving a user input defining special irrigation zones within the one or more areas to be irrigated, wherein the special irrigation zones require more or less water than the rest of the one or more areas to be irrigated.

16. The method of claim 10, wherein determining a spray pattern includes taking into account shade producing objects and applying less water to areas shaded by the shade producing objects.

17. The method of claim 16, wherein determining a spray pattern includes dynamically recalculating a spray pattern of the sprinkler unit to compensate for one or more of: shade producing objects and local weather changes.

18. The method of claim 10, further comprising performing a simulation prior to executing instructions stored in the memory of the control module, to simulate the irrigation of the area in accordance with the determined spray pattern.

19. A computer program product for controlling a sprinkler unit, the computer program product comprising a computer readable storage medium having program instructions embodied therewith, wherein the computer readable storage medium is not a transitory signal per se, the program instructions being executable by a sprinkler unit to cause the sprinkler unit to perform a method comprising:
receiving a user input defining one or more areas to be irrigated by the sprinkler unit, the sprinkler unit including a variable speed rotation motor, a flow valve, and a control module;
determining a spray pattern to achieve desired irrigation of the one or more areas;
storing the determined spray pattern in a memory of the control module; and
executing instructions stored in the memory of the control module to irrigate the one or more areas in accordance with the determined spray pattern.
